(19) United States
(12) Patent Application Publication
(10) Pub. No.: US 2026/0296890 A1
(43) Pub. Date: Oct. 1, 2026

(54) POROUS CARBON MATERIAL AND PREPARATION METHOD THEREOF, AND SILICON-CARBON MATERIAL AND APPLICATION THEREOF

(71) Applicant: Ningde Amperex Technology Limited, Ningde (CN)

(72) Inventor: Min JIANG, Ningde (CN)

(73) Assignee: Ningde Amperex Technology Limited, Ningde (CN)

(21) Appl. No.: 19/574,631

(22) Filed: Mar. 23, 2026

(30) Foreign Application Priority Data
Mar. 26, 2025 (CN) 202510364172.5

(51) Int. Cl. C01B 32/05; H01M 4/02; H01M 4/133; H01M 4/38; H01M 4/583; H01M 10/0525; H01M 10/0568; H01M 10/0569

(52) U.S. Cl. CPC C01B 32/05; H01M 4/133; H01M 4/386; H01M 4/583; H01M 10/0525; H01M 10/0568; H01M 10/0569; C01P 2002/08; C01P 2006/11; C01P 2006/14; C01P 2006/16; C01P 2006/40; H01M 2004/021; H01M 2004/027; H01M 2300/0037

(57) ABSTRACT

A porous carbon material has first pores, second pores, and third pores; where the first pores has a pore size of P₁ nm and 0<P₁≤1; the second pores has a pore size of P₂ nm and 1<P₂≤3; and the third pores has a pore size of P₃ nm and 3<P₃≤10; where based on a sum of the pore volumes of the first pores, the second pores, and the third pores, a volume percentage of the first pores is V₁%, a volume percentage of the second pores is V₂%, and a volume percentage of the third pores is V₃%; where 0.1≤V₁≤10 and 50≤V₂≤95.

### CROSS-REFERENCE TO RELATED APPLICATION

The present application claims priority to Chinese Patent Application No. 202510364172.5 filed in the China National Intellectual Property Administration on Mar. 26, 2025, the entire content of which is hereby incorporated by reference.

### TECHNICAL FIELD

This application belongs to the field of battery material technologies, and specifically relates to a porous carbon material and a preparation method thereof, and a silicon-carbon material and application thereof.

### BACKGROUND

Secondary batteries, such as lithium-ion batteries, are rechargeable battery systems. During charging and discharging, lithium ions intercalate and deintercalate between positive and negative electrodes to achieve storage and release of electric energy. As an important component of a battery, the negative electrode material is crucial to the performance of the battery. Common negative electrode materials include graphite, silicon materials, and the like. Among them, silicon materials have attracted much attention due to their high specific capacity, but the problem of volume swelling during charging and discharging has always been a key factor restricting their application.

During cycling, the volume change rate of silicon is as high as 300%, even higher under high-temperature conditions. Such severe volume swelling generates significant stress inside the battery, changing the physical structure of the electrode material, such as cracking and pulverization. This causes the active material to detach from the electrode plate, compromising the contact between the electrode material and the current collector and thereby causing rapid capacity degradation of the battery. Moreover, swelling may possibly impair the porosity inside the battery, reducing lithium ion transport channels, causing lithium metal precipitation, and affecting battery safety. In addition, when external compression is applied to a silicon-based battery, the negative impact of such volume change is further amplified. Specifically, external compression increases mechanical stress inside the battery, making the silicon material more prone to cracking and pulverization, and may also damage key components such as the separator, triggering internal short circuits and serious safety risks. Therefore, it is necessary to alleviate the high-temperature swelling problem and improve compression safety performance of secondary batteries, so as to enhance their cycling stability and safety.

### SUMMARY

In view of this, this application provides a porous carbon material and a preparation method thereof, and a silicon-carbon material and application thereof. A silicon-carbon material prepared using a porous carbon material with hierarchical pore sizes provides higher first-cycle Coulombic efficiency while improving the high-temperature swelling suppression performance and compression safety performance of a secondary battery.

According to a first aspect, this application provides a porous carbon material having first pores, second pores, and third pores; where the first pores has a pore size of P₁ nm and 0<P₁≤1; the second pores has a pore size of P₂ nm and 1<P₂≤3; and the third pores has a pore size of P₃ nm and 3<P₃≤10; where based on a sum of pore volumes of the first pores, the second pores, and the third pores, a volume percentage of the first pores is V₁%, a volume percentage of the second pores is V₂%, and a volume percentage of the third pores is V₃%; where 0.1≤V₁≤10 and 50≤V₂≤95. In this application, the foregoing characteristics are made available by controlling the hierarchical pore size structure of the porous carbon material. The first pores can enhance the compactness and compressive strength of the porous carbon material. The second pores can provide abundant active sites for depositing silicon material, so that as much silicon material as possible can be deposited in the second pores. This can limit the grain size of the silicon material and mitigate the volume swelling of the silicon material during lithium intercalation and deintercalation. In addition, the second pores and the first pores jointly provide the porous carbon material with excellent mechanical flexibility and structural stability, enhancing the carbon wall strength of the porous carbon material and providing a buffering space for the volume swelling of the silicon material. In this case, internal stress generated by volume changes of the silicon material under high-temperature cycling conditions and stress resulting from external compression can be absorbed and distributed, helping maintain the structural integrity of the silicon-carbon material and the electrode assembly. Moreover, the first pores, second pores, and third pores can work together to absorb and dissipate heat, reducing or preventing thermal runaway caused by local overheating. They can also facilitate rapid transport of lithium ions, improve lithium ion conductivity, reduce the possibility of lithium metal precipitation, and thereby reduce heat accumulation caused by hindered lithium ion transport. Therefore, this application defines that the porous carbon material has a hierarchical pore size structure containing first pores, second pores, and third pores, and controls the pore volume percentages of the first pores and second pores within the foregoing ranges. This can improve the first-cycle Coulombic efficiency of the silicon-carbon material and its electrochemical performance under high-temperature or compression conditions, thereby improving the high-temperature swelling suppression performance and compression safety performance of the secondary battery.

In some embodiments, the porous carbon material satisfies at least one of the following conditions:
(1) 0.5≤V₁≤10;
(2) 50≤V₂≤85;
(3) 5≤V₃≤45; or
(4) 0.1≤V₁/V₃≤20.

This solution can improve the synergy among the first pores, second pores, and third pores in absorbing and distributing internal stress generated by volume changes of the silicon material under high-temperature cycling conditions as well as stress from external compression, reduce pulverization and cracking of the silicon-carbon material, and improve lithium ion conductivity, thereby further improving the first-cycle Coulombic efficiency of the silicon-carbon material as well as the high-temperature swelling suppression performance and compression safety performance of the secondary battery.

In some embodiments, a pore volume of the porous carbon material is 0.50 cm³/g to 1.0 cm³/g; and/or an elastic modulus of the porous carbon material is 1 GPa to 50 GPa, preferably, 23 GPa to 44 GPa. On the basis of the foregoing hierarchical pore size structure, controlling the pore volume and/or elastic modulus of the porous carbon material within these ranges provides the porous carbon material with an appropriate amount of silicon deposition, and balances the energy density and buffering space of the silicon-carbon material. This facilitates absorption and distribution of stress and heat and improve lithium ion conductivity, thereby further improving the first-cycle Coulombic efficiency of the silicon-carbon material as well as the high-temperature swelling suppression performance and compression safety performance of the secondary battery.

This application further provides a method for preparing the foregoing porous carbon material. The method includes the following steps:
step S1: carbonizing a carbon precursor in an inert gas atmosphere to obtain a carbonized material;
step S2: mixing the carbonized material and a pore-forming agent at a mass ratio of 1:(0.2-2.5) to obtain a mixture; and activating the mixture in an inert gas atmosphere to obtain an activated material; where the activation treatment includes sequentially maintaining the temperature at T₁° C. for t₁ hours, maintaining the temperature at T₂° C. for t₂ hours, and maintaining the temperature at T₃° C. for t₃ hours; where 700≤T₁≤800, 0.1≤t₁≤1; 800<T₂≤900, 4≤t₂≤7; and 900<T₃≤1000, 0.5≤t₃≤4; and
step S3: washing the activated material with water and an acid liquid in sequence, and filtering to obtain the porous carbon material.

In this solution, a graded thermal insulation design is adopted for activation treatment of this application because the pore-forming agent and carbonized material present different reaction rates at different temperatures. Through control of thermal insulation duration and temperatures at different stages, the percentages and distribution of first pores, second pores, and third pores in the porous carbon material can be controlled, thereby preparing the porous carbon material with hierarchical pore sizes. This further improves the first-cycle Coulombic efficiency of the silicon-carbon material as well as the high-temperature swelling suppression performance and compression safety performance of the secondary battery.

This application further provides a silicon-carbon material, including a porous carbon material and a silicon material located in pores of the porous carbon material; where the porous carbon material includes any one of the foregoing porous carbon materials or a porous carbon material prepared using the foregoing preparation method; where a grain size of the silicon material is 0.9 nm to 2 nm. In this application, the foregoing hierarchical pore size structure can limit the grain size of the silicon material, mitigate its volume swelling, and increase the utilization rate of the silicon material in electrochemical reactions, thereby improving the first-cycle Coulombic efficiency of the silicon-carbon material. Moreover, this hierarchical pore size structure can further absorb and distribute stress and heat by using the buffering space left after silicon material deposition, enhancing the structural stability of the silicon-carbon material, and improving the high-temperature swelling suppression performance and compression safety performance of the secondary battery.

This application further provides a secondary battery, including a positive electrode, a negative electrode, and an electrolyte; where the negative electrode includes a negative electrode current collector and a negative electrode material layer disposed on at least one surface of the negative electrode current collector; and the negative electrode material layer includes the foregoing silicon-carbon material; where a compacted density of the negative electrode material layer is 0.95 g/cm³ to 1.05 g/cm³. When the compacted density of the negative electrode material layer is further controlled within this range, the energy density and internal buffering space of the secondary battery are balanced, the wettability of silicon-carbon particles in the electrolyte is improved as well as their contact, stresses generated by internal swelling and external compression are distributed, and material cracking and lithium metal precipitation are reduced. This further improves the first-cycle Coulombic efficiency of the silicon-carbon material as well as the high-temperature swelling suppression performance and compression safety performance of the secondary battery.

In some embodiments, the electrolyte contains propylene carbonate and ethylene carbonate, and based on mass of the electrolyte, a sum of mass percentages of propylene carbonate and ethylene carbonate is E %, where 10≤E≤30. Propylene carbonate and ethylene carbonate can promote the formation of a stable solid electrolyte interface film (SEI film), and the high viscosity of propylene carbonate and ethylene carbonate helps improve the compression resistance performance of the battery, but at the cost of lower electrolyte wettability. The hierarchical pore size structure of the porous carbon material in this application can provide appropriate buffering space for the silicon material. Controlling the sum of mass percentages of propylene carbonate and ethylene carbonate in the electrolyte within that range can balance the viscosity and film-forming effect of the electrolyte. The buffering space can also increase lithium ion diffusion paths, helping promote the formation of a more uniform, more stable, and thinner SEI film on the surface of the silicon-carbon material. This can reduce lithium ion consumption in the electrolyte and reduce side reactions between the silicon-carbon material and the electrolyte, helping further improve the first-cycle Coulombic efficiency as well as the high-temperature swelling suppression performance and compression safety performance of the secondary battery.

In some embodiments, the electrolyte contains lithium tetrafluoroborate, and based on the mass of the electrolyte, a mass percentage of lithium tetrafluoroborate is S1%, where 0.01≤S1≤0.8, preferably, 0.05≤S1≤0.6. In this application, lithium tetrafluoroborate is used in the electrolyte. When the mass percentage is within that range, boron-containing and fluorine-containing components can be added to the SEI film on the surface of the silicon-carbon material. Together with these components, ethylene carbonate and propylene carbonate can improve the flexibility and compactness of the SEI film, reduce SEI film cracking and side reactions with the electrolyte, further enhancing the structural stability of the silicon-carbon material in this application. High ionic conductivity of the SEI film, together with the buffering space inside the silicon-carbon material, can further increase the lithium ion transport rate, and reduce or prevent lithium metal precipitation, thereby further improving the first-cycle Coulombic efficiency, high-temperature swelling suppression performance, and compression safety performance of the secondary battery.

In some embodiments, the electrolyte contains lithium bis(trifluoromethanesulfonyl)imide, and based on the mass of the electrolyte, a mass percentage of lithium bis(trifluoromethanesulfonyl)imide is S2%, where 0.05≤S2≤2, preferably, 0.1≤S2≤1.2. In this application, the mass percentage of lithium bis(trifluoromethanesulfonyl)imide in the electrolyte is controlled with this range. Lithium bis(trifluoromethanesulfonyl)imide and lithium tetrafluoroborate can further increase the amounts of inorganic substances such as LiF in the SEI film, improving the compactness, stability, and ionic conductivity of the SEI film. This enhances the lithium ion transport capability of the SEI film and protection for the silicon-carbon material, further improving the first-cycle Coulombic efficiency, high-temperature swelling suppression performance, and compression safety performance of the secondary battery.

In addition, this application further relates to an electronic apparatus, including the foregoing secondary battery.

### DETAILED DESCRIPTION OF EMBODIMENTS

To make the objectives, technical solutions, and advantages of this application clearer, this application will be further described in detail below with reference to embodiments. It should be understood that the specific embodiments described herein are only used to explain this application and are not intended to limit this application.

To solve problems in the prior art, this application provides a porous carbon material having first pores, second pores, and third pores; where the first pores has a pore size of P₁ nm and 0<P₁≤1; the second pores has a pore size of P₂ nm and 1<P₂≤3; and the third pores has a pore size of P₃ nm and 3<P₃≤10; where based on a sum of pore volumes of the first pores, the second pores, and the third pores, a volume percentage of the first pores is V₁%, a volume percentage of the second pores is V₂%, and a volume percentage of the third pores is V₃%; where 0.1≤V₁≤10 and 50≤V₂≤95.

The inventors have found that the foregoing characteristics are made available by controlling the hierarchical pore size structure of the porous carbon material in this application. The first pores can enhance the compactness and compressive strength of the porous carbon material. The second pores can provide abundant active sites for depositing silicon material, so that as much silicon material as possible can be deposited in the second pores. This can limit the grain size of the silicon material and mitigate the volume swelling of the silicon material during lithium intercalation and deintercalation. In addition, the second pores and the first pores jointly provide the porous carbon material with excellent mechanical flexibility and structural stability, enhancing the carbon wall strength of the porous carbon material and providing a buffering space for the volume swelling of the silicon material. In this case, internal stress generated by volume changes of the silicon material under high-temperature cycling conditions and stress resulting from external compression can be absorbed and distributed, helping maintain the structural integrity of the silicon-carbon material and the electrode assembly. Moreover, the first pores, second pores, and third pores can work together to absorb and dissipate heat, reducing or preventing thermal runaway caused by local overheating. They can also facilitate rapid transport of lithium ions, improve lithium ion conductivity, reduce the possibility of lithium metal precipitation, and thereby reduce heat accumulation caused by hindered lithium ion transport. Therefore, this application defines that the porous carbon material has a hierarchical pore size structure containing first pores, second pores, and third pores, and controls the pore volume percentages of the first pores and second pores within the foregoing ranges. This can improve the first-cycle Coulombic efficiency of the silicon-carbon material and its electrochemical performance under high-temperature or compression conditions, thereby improving the high-temperature swelling suppression performance and compression safety performance of the secondary battery.

In some embodiments, 0.1≤V₁≤10, preferably, 0.5≤V₁≤10. For example, the value of V₁ may be 0.1, 0.4, 2.0, 3.2, 3.5, 5.1, 6.1, 7.4, 8.8, 9.5, 10, or a value within a range defined by any two of these values. In this application, controlling the volume percentage of the first pores within this range can enhance the compactness and compressive strength of the porous carbon material, enhance the carbon wall strength of the porous carbon material, and maintain the structural integrity of the silicon-carbon material and electrode assembly under the conditions of silicon material volume swelling and external compression. This improves the first-cycle Coulombic efficiency of the silicon-carbon material as well as the high-temperature swelling suppression performance and compression safety performance of the secondary battery.

In some embodiments, 50≤V₂≤95, preferably, 50≤V₂≤85. For example, the value of V₂ may be 50, 51, 58, 63, 68, 70, 78, 83, 86, 93, 95, or a value within a range defined by any two of these values. In this application, controlling the volume percentage of the second pores in the porous carbon material within this range can limit the grain size of the silicon material, mitigate the volume swelling of the silicon material during lithium intercalation and deintercalation, enhance the mechanical flexibility and structural stability of the porous carbon material, and absorb and distribute stress and heat. This improves the first-cycle Coulombic efficiency of the silicon-carbon material as well as the high-temperature swelling suppression performance and compression safety performance of the secondary battery.

In some embodiments, 5≤V₃≤45. For example, the value of V₃ is 5, 9, 10, 17, 22, 25, 27, 35, 36, 42, 45, or a value within a range defined by any two of these values. In this application, controlling the volume percentage of the third pores in the porous carbon material within this range can provide appropriate buffering space for absorbing and distributing internal and/or external stress and facilitating electrolyte penetration and rapid transport of lithium ions. This improves lithium ion conductivity, and reduces or prevents lithium metal precipitation, thereby maintaining the structural integrity of the silicon-carbon material and the electrode assembly when the silicon material swells and is subjected to external compression. In addition, this can reduce heat accumulation, and reduce or prevent thermal runaway caused by local overheating, thereby improving the first-cycle Coulombic efficiency of the silicon-carbon material as well as the high-temperature swelling suppression performance and compression safety performance of the secondary battery.

In some embodiments, 0.1≤V₁/V₃≤20. For example, the value of V₁/V₃ is 0.1, 2.1, 3.3, 4.6, 7.3, 9.2, 11.9, 14.4, 17.5, 18.5, 20, or a value within a range defined by any two of these values. When the volume percentages of the first pores and third pores satisfy this range, the synergy among the first pores, second pores, and third pores can be comprehensively improved in absorbing and distributing internal and/or external stress. This reduces pulverization and cracking of the silicon-carbon material, and improve lithium ion conductivity, thereby further improving the first-cycle Coulombic efficiency of the silicon-carbon material as well as the high-temperature swelling suppression performance and compression safety performance of the secondary battery.

In some embodiments, a pore volume of the porous carbon material is 0.50 cm³/g to 1.0 cm³/g. For example, the pore volume of the porous carbon material is 0.5 cm³/g, 0.54 cm³/g, 0.60 cm³/g, 0.61 cm³/g, 0.72 cm³/g, 0.74 cm³/g, 0.78 cm³/g, 0.85 cm³/g, 0.90 cm³/g, 0.96 cm³/g, 1 cm³/g, or a value within a range defined by any two of these values. Controlling the pore volume of the porous carbon material within this range helps provide appropriate buffering space for absorbing and distributing internal and/or external stress, and promote sufficient contact between the silicon-carbon material and the electrolyte, improving electrochemical reaction activity. Together with the foregoing pore size distribution, such pore volume helps increase the utilization rate of pores while maintaining a certain specific surface area, thereby improving the performance of the silicon-carbon material in the battery. This further improves the first-cycle Coulombic efficiency of the silicon-carbon material as well as the high-temperature swelling suppression performance and compression safety performance of the secondary battery.

In some embodiments, an elastic modulus of the porous carbon material is 1 GPa to 50 GPa, preferably, 23 GPa to 44 GPa. For example, the elastic modulus of the porous carbon material is 1 GPa, 3 GPa, 8 GPa, 14 GPa, 18 GPa, 26 GPa, 31 GPa, 38 GPa, 40 GPa, 45 GPa, 50 GPa, or a value within a range defined by any two of these values. On the basis of the foregoing hierarchical pore size structure, controlling the elastic modulus of the porous carbon material within this range can improve the mechanical flexibility and structural stability of the porous carbon material, maintain the structural integrity of the silicon-carbon material and the electrode assembly under the conditions of internal swelling and external compression. This further improves the first-cycle Coulombic efficiency of the silicon-carbon material as well as the high-temperature swelling suppression performance and compression safety performance of the secondary battery.

This application further provides a method for preparing the foregoing porous carbon material. The method includes the following steps:
step S1: carbonizing a carbon precursor in an inert gas atmosphere to obtain a carbonized material;
step S2: mixing the carbonized material and a pore-forming agent at a mass ratio of 1:(0.2-2.5) to obtain a mixture; and activating the mixture in an inert gas atmosphere to obtain an activated material; where the activation treatment includes sequentially maintaining the temperature at T₁° C. for t₁ hours, maintaining the temperature at T₂° C. for t₂ hours, and maintaining the temperature at T₃° C. for t₃ hours; and
step S3: washing the activated material with water and an acid liquid in sequence, and filtering to obtain the porous carbon material.

In some embodiments, 700≤T₁≤800, and 0.1≤t₁≤1. For example, T₁ is 700, 710, 720, 740, 750, 760, 770, 780, 790, 800, or a value within a range defined by any two of these values, and t₁ is 0.1, 0.2, 0.3, 0.4, 0.5, 0.6, 0.7, 0.8, 0.9, 1, or a value within a range defined by any two of these values.

In some embodiments, 800<T₂≤900, and 4≤t₂≤7. For example, T₂ is 810, 820, 840, 850, 860, 870, 880, 890, 900, or a value within a range defined by any two of these values, and t₂ is 4, 4.3, 4.6, 4.9, 5.3, 5.7, 6.0, 6.1, 6.4, 6.9, 7, or a value within a range defined by any two of these values.

In some embodiments, 900<T₃≤1000, and 0.5≤t₃≤4. For example, T₃ is 910, 920, 930, 940, 950, 960, 970, 990, 1000, or a value within a range defined by any two of these values, and t₃ is 0.5, 0.8, 1.2, 1.4, 1.9, 2.3, 2.7, 3.1, 3.4, 3.7, 4, or a value within a range defined by any two of these values.

In this solution, a graded thermal insulation design is adopted for activation treatment of this application because the pore-forming agent and carbonized material present different reaction rates at different temperatures. Through control of thermal insulation duration and temperatures at different stages, the percentages and distribution of first pores, second pores, and third pores in the porous carbon material can be controlled, thereby preparing the porous carbon material with hierarchical pore sizes. This further improves the first-cycle Coulombic efficiency of the silicon-carbon material as well as the high-temperature swelling suppression performance and compression safety performance of the secondary battery.

This application does not particularly limit the carbon precursor as long as it can satisfy the requirements of this application. For example, it may be selected from at least one of a biomass precursor, a sugar precursor, a synthetic resin precursor, or a pitch precursor.

In some embodiments, the temperature of the carbonization treatment is 600° C. to 1400° C., and the duration is 2 hours to 8 hours.

In some embodiments, the pore-forming agent may be selected from at least one of potassium hydroxide, potassium carbonate, potassium bicarbonate, or potassium chloride, especially at least one of potassium hydroxide, potassium carbonate, or potassium bicarbonate, or a mixture of potassium chloride and at least one of potassium hydroxide, potassium carbonate, or potassium bicarbonate.

In some embodiments, in the acid liquid for washing, a molar concentration of hydrogen ions is 0.1 mol/L to 2 mol/L, and the acid liquid may be hydrochloric acid.

This application further provides a silicon-carbon material, including a porous carbon material and a silicon material located in pores of the porous carbon material; where the porous carbon material includes any one of the foregoing porous carbon materials or a porous carbon material prepared using the forgoing preparation method; where a grain size of the silicon material is 0.9 nm to 2 nm. For example, the grain size of the silicon material is 0.9 nm, 1.1 nm, 1.2 nm, 1.3 nm, 1.4 nm, 1.6 nm, 1.7 nm, 1.8 nm, 1.9 nm, 2 nm, or a value within a range defined by any two of these values. In this application, the foregoing hierarchical pore size structure can limit the grain size of the silicon material, mitigate its volume swelling, and increase the utilization rate of the silicon material in electrochemical reactions, thereby improving the first-cycle Coulombic efficiency of the silicon-carbon material. Moreover, this hierarchical pore size structure can further absorb and distribute stress and heat by using the buffering space left after silicon material deposition, enhancing the structural stability of the silicon-carbon material, and improving the high-temperature swelling suppression performance and compression safety performance of the secondary battery.

In some embodiments, the silicon-carbon material further includes an amorphous carbon layer located on a surface of the porous carbon material.

The silicon-carbon material of this application may be prepared using a method including the following steps:
placing the porous carbon material in a rotary furnace, introducing an inert atmosphere and raising the temperature to 450-600° C., introducing silane gas for chemical vapor deposition, maintaining the temperature for 2 hour to 8 hours, stopping the introduction of silane gas, raising the temperature to 500-650° C. in an inert atmosphere, and introducing alkane gas and maintaining the temperature for 2 hour to 8 hours to obtain the silicon-carbon material, and then cooling down to room temperature.

In some embodiments, the silane gas may be at least one of monosilane or disilane, and the alkane gas may be at least one of methane, ethane, ethylene, or acetylene. This application does not particularly limit the inert gas involved in the preparation as long as the objective of this application can be achieved. For example, the inert gas may be at least one of nitrogen, argon, or helium.

This application further provides a secondary battery, including a positive electrode, a negative electrode, and an electrolyte.

### Secondary Battery

The secondary battery of this application is not particularly limited and is classified into various categories depending on the type of electron transport substance. For example, when the electron transport substance is lithium (Li, including ions), the secondary battery is a lithium-ion battery; and when the electron transport substance is sodium (Na, including ions), the secondary battery is a sodium-ion battery.

According to an embodiment of this application, the secondary battery may include a battery cell and an electrolyte. The battery cell may include a packaging material and an electrode assembly disposed inside the packaging material, and the electrolyte may be filled in the internal space formed by the packaging material. The packaging material can protect the electrode assembly from external impact and prevent the electrolyte from leaking to the outside. Depending on the shape of the packaging material, the battery cell may be prismatic, cylindrical, or pouch type.

The electrode assembly includes a positive electrode, a negative electrode, and a separator, as well as other components known in the art in secondary batteries, which are not limited in this application. The separator may be interposed between the positive electrode and the negative electrode.

This application does not particularly limit the preparation method of a secondary battery. For example, the method may include the following steps: stacking the positive electrode, the separator, and the negative electrode in sequence, and winding or folding them as required to obtain an electrode assembly, placing the electrode assembly into a packaging material, and injecting the electrolyte into the packaging material and sealing, to obtain a secondary battery.

### Positive Electrode

In this application, the positive electrode is not particularly limited as long as the objective of this application can be achieved. The positive electrode includes a positive electrode current collector and a positive electrode material layer disposed on at least one surface of the positive electrode current collector. Disposing the positive electrode material layer on at least one surface of the positive electrode current collector means that the positive electrode material layer may be located on one surface of the positive electrode current collector in its thickness direction or on both surfaces of the positive electrode current collector in its thickness direction. It should be noted that the “surface” herein may be partial or entire area of the surface of the positive electrode current collector, which is not particularly limited in this application as long as the objective of this application can be achieved.

This application does not particularly limit the type, size, and shape of the positive electrode current collector as long as it does not cause chemical changes in the battery cell and is conductive. For example, the positive electrode current collector may be made of stainless steel, aluminum, nickel, titanium, calcined carbon, or a material obtained by treating the surface of aluminum or stainless steel with carbon, nickel, titanium, silver, or the like. In this application, the positive electrode current collector may further contain a non-metal element. For example, the non-metal element includes at least one of fluorine, phosphorus, boron, chlorine, silicon, or sulfur.

The positive electrode current collector may have an appropriate thickness as required. Although not particularly limited, the positive electrode current collector may have a thickness in the range of 1 μm to 500 μm, 1 μm to 300 μm, 1 μm to 100 μm, 1 μm to 50 μm, or 1 μm to 20 μm.

Unless otherwise specified, the terms thickness (or height), width, and length used in this application refer to average values, and can be measured by measuring instruments capable of measuring thickness (or height), width, and length respectively and according to methods known in the art.

Fine concavities and convexities may be formed on the surface of the positive electrode current collector, further enhancing the adhesion to the positive electrode material layer. For example, the form of the positive electrode current collector may be one or more selected from a group consisting of foil, sheet, film, net, porous body, foam, and non-woven fabric.

In this application, the positive electrode material layer includes a positive electrode active material, and this application does not particularly limit the type of the positive electrode active material as long as the objective of this application can be achieved. For example, the positive electrode active material may include at least one of lithium nickel cobalt manganate (LiNi_{0.90}Co_{0.05}Mn_{0.05}O₂ (NCM₉₅₅), NCM₈₁₁, NCM₆₂₂, NCM₅₂₃, NCM₁₁₁), lithium nickel cobalt aluminate, lithium iron phosphate, lithium vanadium phosphate, lithium cobalt phosphate, lithium manganese phosphate, lithium manganese iron phosphate, lithium-rich manganese-based material, lithium cobalt oxide (LiCoO₂), lithium iron silicate, lithium vanadium silicate, lithium cobalt silicate, lithium manganese silicate, spinel lithium manganese oxide, spinel lithium nickel manganese oxide, and lithium titanate. In this application, the positive electrode active material may alternatively contain a non-metal element. For example, the non-metal element includes at least one of fluorine, phosphorus, boron, chlorine, silicon, or sulfur. In this application, the thicknesses of the positive electrode current collector and the positive electrode material layer are not particularly limited as long as the objective of this application can be achieved.

In some embodiments, the positive electrode material layer may further include a positive electrode binder. This application does not particularly limit the type of the positive electrode binder as long as the objective of this application can be achieved. For example, the positive electrode binder may include but is not limited to at least one of polyvinylidene fluoride, polytetrafluoroethylene, polyolefin, sodium carboxymethyl cellulose, lithium carboxymethyl cellulose, modified polyvinylidene fluoride, modified styrene-butadiene rubber (SBR), polyester, polyalcohol, polyacrylic acid, or polyurethane. In some embodiments, the polyolefin binder includes at least one of polyethylene or polypropylene.

In some embodiments, the positive electrode material layer may further include a conductive agent. This application does not particularly limit the type of the conductive agent in the positive electrode material layer as long as the objective of this application can be achieved. In some exemplary embodiments, the conductive agent includes a carbon-based material, for example, graphite such as natural graphite or artificial graphite, carbon black such as acetylene black, Ketjen black, channel black, furnace black, lamp black, or thermal black, or carbon fiber; a conductive polymer, for example, a polyphenyl derivative; a conductive metal oxide, for example, zinc oxide or titanium oxide; a conductive whisker, for example, potassium titanate; or a mixture formed by any combination of these substances.

In this application, the positive electrode material layer may be formed by applying a positive electrode slurry on at least one surface of the positive electrode current collector and drying, and then the slurry may be calendered when required. The positive electrode slurry includes the foregoing positive electrode active material, positive electrode binder, and conductive agent. In addition, the positive electrode slurry may further include a solvent, and this application does not particularly limit the type of the solvent as long as the objective of this application can be achieved. For example, the solvent may be N-methyl-2-pyrrolidone.

This application does not particularly limit the mass ratio of the positive electrode active material, conductive agent, and positive electrode binder in the positive electrode material layer, and those skilled in the art may select according to actual needs as long as the objective of this application can be achieved. A known mass ratio may be used.

### Negative Electrode

This application does not particularly limit the negative electrode as long as the objective of this application can be achieved. For example, the negative electrode includes a negative electrode current collector and a negative electrode material layer disposed on at least one surface of the negative electrode current collector. In this application, the negative electrode material layer may be disposed on one surface of the negative electrode current collector in the thickness direction or on both surfaces of the negative electrode current collector in the thickness direction. It should be noted that the “surface” herein may be partial or entire area of the negative electrode current collector, which is not particularly limited in this application as long as the objective of this application can be achieved.

In some embodiments, the negative electrode material layer includes a negative electrode active material, and the negative electrode active material includes the foregoing silicon-carbon material. A compacted density of the negative electrode material layer is 0.95 g/cm³ to 1.05 g/cm³. For example, the compacted density of the negative electrode material layer is 0.95 g/cm³, 0.96 g/cm³, 0.97 g/cm³, 0.98 g/cm³, 0.99 g/cm³, 1.00 g/cm³, 1.01 g/cm³, 1.02 g/cm³, 1.03 g/cm³, 1.04 g/cm³, 1.05 g/cm³, or a value within a range defined by any two of these values. When the compacted density of the negative electrode material layer is further controlled within this range, the energy density and internal buffering space of the secondary battery are balanced, the wettability of silicon-carbon particles in the electrolyte is improved as well as their contact, stresses generated by internal swelling and external compression are distributed, and material cracking and lithium metal precipitation are reduced. This further improves the first-cycle Coulombic efficiency of the silicon-carbon material as well as the high-temperature swelling suppression performance and compression safety performance of the secondary battery.

This application does not particularly limit the type, size, and shape of the negative electrode current collector as long as it does not cause chemical changes in the battery cell and is conductive. For example, the negative electrode current collector may be made of stainless steel, copper, nickel, titanium, calcined carbon, or a substance obtained by treating the surface of copper or stainless steel with carbon, nickel, titanium, silver, or the like.

The negative electrode current collector may have an appropriate thickness as required. Although not particularly limited, the negative electrode current collector may have a thickness in the range of 1 μm to 500 μm, 1 μm to 300 μm, 1 μm to 100 μm, 1 μm to 50 μm, 1 μm to 20 μm, or 5 μm to 10 μm.

Fine concavities and convexities may be formed on the surface of the negative electrode current collector, further enhancing the adhesion to the negative electrode material layer. For example, the form of the negative electrode current collector may be one or more selected from a group consisting of foil, sheet, film, net, porous body, foam, and non-woven fabric.

In some embodiments, the negative electrode active material may further include another material, for example, including but not limited to a carbon material such as graphite (artificial graphite, natural graphite, or graphitized carbon fiber) or amorphous carbon; a metals capable of being alloyed with lithium or a lithium alloy such as Si, Al, Sn, Pb, Zn, Bi, In, Mg, Ga, Cd, Si alloy, Sn alloy, or Al alloy; a metal oxide, capable of being doped with lithium or with lithium dedoped, or a lithium alloy such as SiO_{β} (0<β≤2), SnO, SnO₂, vanadium oxide, or lithium vanadium oxide; or a composite containing the metal and carbon material such as a Si—C composite or a Sn—C composite; spinel-structure lithium titanate TiO₂—Li₄Ti₅O₁₂, or any one thereof or a mixture of two or more thereof. Specifically, the carbon material may be low-crystallinity carbon, high-crystallinity carbon, or the like. Representative low-crystallinity carbon is soft carbon and hard carbon. An example of high-crystallinity carbon may be amorphous, plate-shaped, flake-shaped, spherical, or fibrous natural graphite or artificial graphite, pristine graphite, pyrolytic carbon, mesophase pitch-based carbon fiber, carbon microsphere (mesophase carbon microsphere), mesophase pitch, or high-temperature calcined carbon such as petroleum or coal-based coke (coke derived from petroleum or coal tar pitch).

The negative electrode material layer in this application further includes a negative electrode binder. This application does not particularly limit the type of the negative electrode binder as long as the objective of this application can be achieved. For example, the negative electrode binder may include but is not limited to at least one of polyvinylidene fluoride (PVDF), polyvinyl alcohol, styrene-butadiene rubber (SBR), polyethylene oxide, carboxymethyl cellulose (CMC), hydroxypropyl cellulose, cellulose acetate, cellulose diacetate, cellulose acetate butyrate, cellulose acetate propionate, cyanoethyl pullulan, cyanoethyl polyvinyl alcohol, cyanoethyl cellulose, cyanoethyl sucrose, pullulan, polymethyl methacrylate, polybutyl acrylate, polyacrylonitrile, polyvinylpyrrolidone, polyvinyl acetate, ethylene-vinyl acetate copolymer, polyarylate, polyvinyl chloride, carboxylated polyvinyl chloride, polyvinyl fluoride, polymers containing ethylene oxide, polyurethane, polytetrafluoroethylene, polyethylene, polypropylene, polyacrylic acid, styrene-butadiene rubber, acrylated styrene-butadiene rubber, epoxy resin, or nylon.

This application does not particularly limit the type of the conductive agent in the negative electrode material layer as long as the objective of this application can be achieved. In some exemplary embodiments, the conductive agent includes a carbon-based material, for example, graphite such as natural graphite or artificial graphite, carbon black such as acetylene black, Ketjen black, channel black, furnace black, lamp black, or thermal black, or carbon fiber; a metal-based material, for example, metal powder or metal fiber of copper, nickel, aluminum, silver, or the like; a conductive polymer, for example, a polyphenyl derivative; a conductive metal oxide, for example, zinc oxide or titanium oxide; a conductive whisker, for example, potassium titanate; or a mixture formed by any combination of these substances.

This application does not particularly limit the mass ratio of the negative electrode active material, negative electrode conductive agent, and negative electrode binder in the negative electrode material layer, and those skilled in the art may select according to actual needs as long as the objective of this application can be achieved. A known mass ratio may be used.

In this application, the negative electrode material layer may be formed by applying a negative electrode slurry on at least one surface of the negative electrode current collector and drying, and then the slurry may be calendered when required. The negative electrode slurry includes the foregoing negative electrode active material and negative electrode binder, and may further include a conductive agent when required. In addition, the negative electrode slurry may further include a solvent, and this application does not particularly limit the type of the solvent as long as the objective of this application can be achieved. For example, the solvent may be deionized water.

### Separator

The separator of this application is used to prevent short circuit between the positive electrode and the negative electrode while allowing the passage of electron transport substances. This application does not particularly limit the separator as long as the objective of this application can be achieved. For example, a material of the separator may include but is not limited to at least one of polyethylene (PE)- and polypropylene (PP)-based polyolefin (PO), a polyester (for example, polyethylene terephthalate (PET) membrane), cellulose, polyimide (PI), polyamide (PA), spandex, or aramid; and the type of the separator may include at least one of woven membrane, non-woven membrane, microporous membrane, composite membrane, calendered membrane, or spun membrane.

According to some embodiments of this application, the separator may include a substrate layer and a surface treatment layer. The substrate layer may be a non-woven fabric, membrane, or composite membrane having a porous structure, and a material of the substrate layer may include at least one of polyethylene, polypropylene, polyethylene terephthalate, or polyimide. Optionally, a polypropylene porous membrane, a polyethylene porous membrane, a polypropylene non-woven fabric, a polyethylene non-woven fabric, or a polypropylene-polyethylene-polypropylene porous composite membrane may be used.

Optionally, the surface treatment layer is disposed on at least one surface of the substrate layer, and the surface treatment layer may be a polymer layer or an inorganic substance layer, or a layer formed by mixing a polymer and an inorganic substance. For example, the inorganic substance layer contains inorganic particles and a binder. The inorganic particle is not particularly limited in this application, and may, for example, include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. This application does not particularly limit the binder, which may be, for example, at least one of the foregoing positive electrode binder or negative electrode binder. The polymer layer contains a polymer, which is not particularly limited in this application. For example, the polymer includes at least one of polyamide, polyacrylonitrile, acrylate polymer, polyacrylic acid, polyacrylate, polyvinylpyrrolidone, polyvinyl ether, polyvinylidene fluoride, or poly(vinylidene fluoride-hexafluoropropylene). In this application, the thickness of the separator is not particularly limited as long as the objective of this application can be achieved. For example, the thickness of the separator may be 5 μm to 500 μm.

### Electrolyte

In this application, the electrolyte refers to a medium that causes electron transport substances to move for smooth electrochemical reactions of the positive electrode and the negative electrode. The electrolyte may be a commonly used organic liquid electrolyte, inorganic liquid electrolyte, gel polymer electrolyte, molten-type inorganic electrolyte, or the like, which is not limited thereto. A solid electrolyte such as a gel polymer electrolyte may alternatively be used instead of the electrolyte. A battery using a solid electrolyte is generally called a solid-state battery or an all-solid-state battery. A liquid electrolyte (electrolyte) generally contains a non-aqueous solvent and a lithium salt.

In some embodiments, the electrolyte contains propylene carbonate and ethylene carbonate, and based on mass of the electrolyte, a sum of mass percentages of propylene carbonate and ethylene carbonate is E %, where 10≤E≤30. For example, E may be 10, 11, 14, 17, 18, 20, 22, 25, 27, 29, 30, or a value within a range defined by any two of these values. Propylene carbonate and ethylene carbonate can promote the formation of a stable solid electrolyte interface film (SEI film), and the high viscosity of propylene carbonate and ethylene carbonate helps improve the compression resistance of the battery, but at the cost of lower electrolyte wettability. The hierarchical pore size structure of the porous carbon material in this application can provide appropriate buffering space for the silicon material. Controlling the sum of mass percentages of propylene carbonate and ethylene carbonate in the electrolyte within that range can balance the viscosity and film-forming effect of the electrolyte. The buffering space can also increase lithium ion diffusion paths, helping promote the formation of a more uniform, more stable, and thinner SEI film on the surface of the silicon-carbon material. This can reduce lithium ion consumption in the electrolyte and reduce side reactions between the silicon-carbon material and the electrolyte, helping further improve the first-cycle Coulombic efficiency as well as the high-temperature swelling suppression performance and compression safety performance of the secondary battery.

In some embodiments, based on the mass of the electrolyte, a mass percentage of propylene carbonate is 2% to 17%, and a mass percentage of ethylene carbonate is 6% to 16%.

In some embodiments, the electrolyte contains lithium tetrafluoroborate, based on the mass of the electrolyte, and a mass percentage of lithium tetrafluoroborate is S1%, where 0.01≤S1≤0.8, preferably, 0.05≤S1≤0.6. For example, S1 is 0.05, 0.10, 0.14, 0.20, 0.29, 0.35, 0.40, 0.45, 0.52, 0.59, 0.6, or a value within a range defined by any two of these values. In this application, lithium tetrafluoroborate is used in the electrolyte. When the mass percentage is within that range, boron-containing and fluorine-containing components can be added to the SEI film on the surface of the silicon-carbon material. Together with these components, ethylene carbonate and propylene carbonate can improve the flexibility and compactness of the SEI film, reduce SEI film cracking and side reactions with the electrolyte, further enhancing the structural stability of the silicon-carbon material in this application. High ionic conductivity of the SEI film, together with the buffering space inside the silicon-carbon material, can further increase the lithium ion transport rate, and reduce or prevent lithium metal precipitation, thereby further improving the first-cycle Coulombic efficiency, high-temperature swelling suppression performance, and compression safety performance of the secondary battery.

In some embodiments, the electrolyte contains lithium bis(trifluoromethanesulfonyl)imide, and based on the mass of the electrolyte, a mass percentage of lithium bis(trifluoromethanesulfonyl)imide is S2%, where 0.05≤S2≤2, preferably, 0.1≤S2≤1.2. For example, S2 is 0.05, 0.20, 0.38, 0.58, 0.81, 0.97, 1.31, 1.46, 1.77, 1.86, 2, or a value within a range defined by any two of these values. In this application, the mass percentage of lithium bis(trifluoromethanesulfonyl)imide in the electrolyte is controlled with this range. Lithium bis(trifluoromethanesulfonyl)imide and lithium tetrafluoroborate can further increase the amounts of inorganic substances such as LiF in the SEI film, improving the compactness, stability, and ionic conductivity of the SEI film. This enhances the lithium ion transport capability of the SEI film and protection for the silicon-carbon material, further improving the first-cycle Coulombic efficiency, high-temperature swelling suppression performance, and compression safety performance of the secondary battery.

According to some embodiments of this application, the lithium salt may alternatively include but is not limited to at least one of lithium hexafluorophosphate (LiPF₆), lithium difluorophosphate (LiPO₂F₂), lithium bis(fluorosulfonyl)imide {Li(N(SO₂F)₂), LiFSI}, lithium bis(oxalato) borate {LiB(C₂O₄)₂, LiBOB}, lithium difluoro(oxalato)borate {LiBF₂(C₂O₄), LiDFOB}, LiNO₃, LiClO₄, LiB(C₆H₅)₄, LiCH₃SO₃, LiCF₃SO₃, LiC(SO₂CF₃)₃, Li₂SiF₆, or lithium difluoroborate. This application does not limit the amount of the lithium salt in the electrolyte as long as the objective of this application can be achieved.

This application does not particularly limit the non-aqueous solvent. For example, the non-aqueous solvent may include but is not limited to at least one of a carbonate compound, a carboxylate compound, an ether compound, or another organic solvent. The carbonate compound may include but is not limited to at least one of a chain carbonate compound, a cyclic carbonate compound, or a fluorinated carbonate compound. The chain carbonate compound may include but is not limited to at least one of dimethyl carbonate (DMC), diethyl carbonate (DEC), dipropyl carbonate, methyl propyl carbonate, ethyl propyl carbonate, or methyl ethyl carbonate (EMC). The cyclic carbonate may include but is not limited to at least one of butylene carbonate or vinyl ethylene carbonate. The fluorinated carbonate compound may include but is not limited to at least one of 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compound may include but is not limited to at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The ether compound may include but is not limited to at least one of 1,3-dioxolane (DOL), ethylene glycol dimethyl ether (1,2-dimethoxyethane, DME), dibutyl ether, tetraglyme, diglyme, 1,2-diethoxyethane, 1-ethoxy-1-methoxyethane, 2-methyltetrahydrofuran, or tetrahydrofuran.

### Electronic Apparatus

This application provides an electronic apparatus including the foregoing secondary battery. The electronic apparatus of this application is not particularly limited and may be any electronic apparatus known in the prior art. For example, the electronic apparatus may include but is not limited to a notebook computer, a pen-based computer, a mobile computer, an electronic book reader, a portable telephone, a portable facsimile machine, a portable copier, a portable printer, a stereo headset, a video recorder, a liquid crystal television, a handheld cleaner, a portable CD player, a mini disc, a transceiver, an electronic notebook, a calculator, a memory card, a portable recorder, a radio, a backup power supply, a motor, an automobile, a motorcycle, a motorized bicycle, a bicycle, a lighting appliance, a toy, a game console, a clock, an electric power tool, a flash lamp, a camera, a large household battery, or a lithium-ion capacitor.

### Measurement Methods

The physical properties mentioned in this application may be measured using the following methods, and the physical properties in the following examples and comparative examples are measured using the following methods.

### Test of Pore Volume and Pore Size

A physisorption analyzer (model: iPore 620) was used to test the porous carbon material according to the following procedure: putting 0.15 g of the porous carbon material sample into a sample tube, degassing at 200° C. for 6 hours, and then testing the amount of argon gas absorbed by the sample under different relative pressures. An isothermal adsorption curve of the sample was drawn. The single-point adsorption pore volume of the sample was calculated as the pore volume of the porous carbon material. The pore size distribution was calculated through NLDFT, and then the volume percentages of first pores, second pores, and third pores were calculated accordingly.

### Elastic Modulus Test

Particles with a particle size of 8-10 μm were taken for crushing force test by a Shimadzu single-particle crushing instrument (FLAT50), with the minimum/maximum pressure set to 0.02/10 mN. The elastic modulus of the sample was calculated according to the deformation amount and approximate contact area under the maximum pressure, using Hooke's law and the pressure formula.

### Grain Size Test

An XRD X-ray powder diffractometer (model: BRUKER D8 Advance) was used to test a Cu target (λ=1.54178 Å). The porous carbon material sample under test was filtered with a 200-mesh sieve. The powder passing through the sieve was loaded into a sample pool, with the surface flattened, and excess powder around was cleaned up. The sample under test was put into the XRD X-ray powder diffractometer for testing to acquire an XRD pattern. Based on the measured XRD pattern, the half-peak width and interplanar spacing corresponding to the diffraction peak of silicon (111) or (220) plane was found. The diffraction angle was calculated according to Bragg's equation, and then the size of silicon grains was calculated according to Scherrer's equation, D=Kλ/β cos θ.

### First-Cycle Coulombic Efficiency Test

Electrode preparation: The silicon-carbon material according to an example or comparative example was used as the negative electrode active material. The negative electrode active material, a conductive agent (carbon nanotubes (CNT)), a binder (polymethyl acrylate), and a thickener (sodium carboxymethyl cellulose (CMC)) were fully stirred and mixed at a weight ratio of 95.7:1.5:1.8:1 in a solvent deionized water to form a uniform negative electrode slurry. The negative electrode slurry was uniformly applied on a negative electrode current collector copper foil, dried, and cold pressed to form a negative electrode active substance layer, and then a negative electrode plate was obtained after cutting and tab welding.

Button cell assembly: Metallic lithium was as a counter electrode. A metallic lithium sheet with a diameter of 18 mm and a thickness of 0.6 mm, a separator (12 μm porous polyethylene membrane), and the negative electrode plate (cut into a diameter of 18 mm) according to an example and comparative example were stacked in sequence, and the electrolyte according to an example and comparative example was added, followed by packaging in button-type stainless-steel positive and negative electrode shells, so as to obtain a button cell.

At 25° C., the button cell was left standing for 4 hours, discharged to 5 mV at a constant current of 0.02 C, left standing for 5 minutes, and then charged to 2.0 V at a constant current of 0.02 C. The first-cycle charge and discharge capacities were recorded. First-cycle Coulombic efficiency=first-cycle charge capacity/first-cycle discharge capacity.

### Test of High-Temperature Cycling Thickness

A full lithium-ion battery was placed in a 25±1° C. thermostat and left standing for 30 minutes, and the initial thickness H₀ of the full lithium-ion battery was recorded. The full lithium-ion battery was placed in a 45±1° C. thermostat and left standing for 60 minutes, and a charge-discharge test was performed under the following conditions. The battery was charged to 4.53 V at a constant current of 0.5 C, charged to 0.025 C at a constant voltage of 4.53 V, left standing for 5 minutes, and then discharged to 3.0 V at 0.5 C. This process was referred to as one charge-discharge cycle. 500 cycles were performed, and the thickness H₁ was recorded after the 500^{th} cycle.

Cycling swelling rate=(H₁−H₀)/H₀×100%.

### Screw Compression Test

The full lithium-ion battery according to an example or comparative example was placed in a 25° C. thermostat and left standing for 30 minutes, and a charge-discharge test was performed under the following conditions. The battery was charged to 4.53 V at a constant current of 0.5 C, charged to 0.025 C at a constant voltage of 4.53 V, left standing for 5 minutes, and then discharged to 3.0 V at 0.5 C. This process was referred to as one charge-discharge cycle. 100 cycles were performed.

The full lithium-ion battery was placed on a pressure plate, and a test screw was placed on the surface of the full lithium-ion battery. A pressurizing device was used to exert pressure perpendicular to the plate direction, applying a compression force of 13 kN between two pressure plates. Specifically, 20 N of preloading force was recorded as the initial pressure, and the compression speed was 15 kN/min. The test was stopped when the pressure reached 13 kN. If the full lithium-ion battery does not catch fire or explode, it has passed the screw compression test. 10 full lithium-ion batteries were used each time for parallel testing according to the foregoing steps, and the number of batteries that passed the test were recorded. For example, 4/10 indicates that 4 out of 10 full lithium-ion batteries under test have passed the screw compression test.

The solution of this application will be described by taking lithium-ion batteries as an example and with reference to the following specific examples. Unless otherwise specified, the raw materials used in the following examples are all commercially available, and the apparatuses or devices used are all purchased from conventional market sales channels.

### Example 1-1

### Preparation Method of Silicon-Carbon Material

Step S1. 1 kg of synthetic resin carbon precursor was placed in an oven, nitrogen was introduced, air was excluded, the temperature was raised to 600° C. and kept for 3 hours, and then the temperature was reduced to obtain a carbonized material.

Step S2. The carbonized material and a pore-forming agent were mixed at a mass ratio of 1:1.2, the mixture was placed in a rotary furnace, nitrogen was introduced, air was excluded, the temperature was raised to 750° C. and kept for 0.3 hours, the temperature was raised to 860° C. and kept for 5 hours, the temperature was raised to 950° C. and kept for 1 hour, and then the temperature was reduced to obtain an activated material.

Step S3. The activated material was washed with 10 L of water and then cleaned with 10 L of 1 mol/L hydrochloric acid solution for cleaning, followed by suction filtration and drying, to obtain a porous carbon material.

Step S4. The porous carbon was placed in a rotary furnace, an inert atmosphere was introduced, the temperature was raised to 500° C., monosilane gas was introduced and the temperature was kept for 4 hours for chemical vapor deposition, monosilane gas introduction was stopped, methane gas was introduced, the temperature was raised to 550° C. and kept for 4 hours, and then the temperature was reduced to room temperature to obtain a silicon-carbon material.

### Preparation of Negative Electrode

The silicon-carbon material and artificial graphite are mixed at a mass ratio of 1:9 to obtain a negative electrode active material. The negative electrode active material (95 wt %), conductive carbon black (0.5 wt %), polymethyl acrylate (3.5%), and carboxymethyl cellulose (1%) were mixed, deionized water was added, and then the mixture was stirred to uniformity to prepare a negative electrode slurry. The negative electrode slurry was uniformly applied on one surface of a copper foil and dried. The foregoing steps were repeated on another surface of the copper foil to obtain a negative electrode plate with the negative electrode material layer coated on both sides. The coated copper foil was dried, pressed, and cut into a specified size, followed by tab welding, to obtain a negative electrode.

### Preparation of Positive Electrode

Lithium cobalt oxide (97 wt %), conductive carbon black (1.5 wt %), polyvinylidene fluoride (1.5 wt %) were dissolved in N-methylpyrrolidone to prepare a positive electrode slurry. The positive electrode slurry was uniformly applied on one surface of an aluminum foil and dried. The coating step was repeated on another surface of the aluminum foil to obtain a positive electrode plate with a positive electrode material layer coated on both sides. The coated aluminum foil was dried, pressed, and cut into a specified size, followed by tab welding, to obtain a positive electrode.

### Preparation of Separator: a 7 μm-Thick Polyethylene/Polypropylene Composite Porous Membrane was Used as the Separator

### Preparation of electrolyte

In an argon atmosphere glove box with a water content of less than 10 ppm, dimethyl carbonate and diethyl carbonate were mixed at a mass ratio of 1:1 to obtain a base solvent. Propylene carbonate, ethylene carbonate, fluoroethylene carbonate, 1,3-propane sultone, and lithium hexafluorophosphate were added to the base solvent and mixed to uniformity to obtain an electrolyte. Based on the mass of the electrolyte, a mass percentage of propylene carbonate is 12%, a mass percentage of ethylene carbonate is 6%, a mass percentage of fluoroethylene carbonate is 12%, a mass percentage of 1,3-propane sultone is 1%, and a mass percentage of lithium hexafluorophosphate is 12.5%.

### Battery Assembly

The positive electrode, the separator, and the negative electrode were stacked in sequence, with the separator positioned between the positive electrode and the negative electrode for isolation, and wound to obtain an electrode assembly. The electrode assembly was placed in an outer packaging aluminum-plastic film, baked, injected with the foregoing electrolyte, and then subjected to processes including vacuum packaging, standing, formation, shaping, and capacity testing to obtain a lithium-ion battery.

### Examples 1-2 to 1-12, Comparative Examples 1-1 to 1-3

The difference from Example 1-1 lies only in that: the volume percentage V₁% of first pores, the volume percentage V₂% of second pores, and the volume percentage V₃% of third pores based on the sum of the pore volumes of first pores, second pores, and third pores in the porous carbon material, the pore volume of the porous carbon material, the elastic modulus, the grain size of the silicon material in the silicon-carbon material, and the compacted density of the negative electrode material layer are adjusted according to Table 1. The specific adjustments to parameters and performance test results are shown in Table 1. Controlling the temperature and duration of the graded thermal insulation during activation treatment can control the volume percentages of first pores, second pores, and third pores. For example, within the scope of this application, a greater value for T₁ and/or a greater value for t₁ can increase the volume percentage of first pores; a greater value for T₂ and/or a greater value for t₂ can increase the volume percentage of second pores; and a smaller value for T₃ and/or a smaller value for t₃ can reduce the volume percentage of third pores. In Comparative Example 1-2, the activation treatment only adopts two-stage graded thermal insulation, and thermal insulation at the T₃ stage is not involved.

TABLE 1

| | Volume | | Volume | | | | | | | | |
|---|---|---|---|---|---|---|---|---|---|---|---|
| | per- | Volume | per- | | | | | | | High- | |
| | centage | percentage | centage | | | | | Com- | First-cycle | temperature | Com- |
| | of first | of second | of third | | Pore | Elastic | Grain | pacted | Coulombic | thickness | pression |
| | pores V₁ | pores V₂ | pores V₃ | | volume | modulus | size | density | efficiency | swelling | test |
| No. | (%) | (%) | (%) | V₁/V₃ | (cm³/g) | (GPa) | (nm) | (g/cm³) | (%) | rate (%) | pass rate |
| Comparative | 0.05 | 96 | 3.95 | 0.012 | 0.67 | 37 | 1.2 | 0.99 | 82.7 | 12.6 | 0/10 |
| Example 1-1 | | | | | | | | | | | |
| Comparative | 10.5 | 89.5 | 0 | 1 | 0.36 | 51 | 0.5 | 0.99 | 83.5 | 11.5 | 0/10 |
| Example 1-2 | | | | | | | | | | | |
| Comparative | 5 | 48 | 47 | 0.11 | 1.44 | 0.7 | 3.0 | 0.99 | 83.5 | 12.2 | 0/10 |
| Example 1-3 | | | | | | | | | | | |
| Example 1-1 | 2 | 82 | 16 | 0.125 | 0.86 | 27 | 1.7 | 0.99 | 88.0 | 10.2 | 6/10 |
| Example 1-2 | 0.1 | 95 | 4.9 | 0.02 | 0.69 | 37 | 1.2 | 0.99 | 84.9 | 11.6 | 1/10 |
| Example 1-3 | 0.5 | 85 | 14.5 | 0.03 | 0.88 | 28 | 1.7 | 0.99 | 87.4 | 10.3 | 4/10 |
| Example 1-4 | 1.5 | 83.5 | 15 | 0.10 | 0.86 | 28 | 1.7 | 0.99 | 87.7 | 10.2 | 5/10 |
| Example 1-5 | 5 | 81 | 14 | 0.36 | 0.77 | 33 | 1.5 | 0.99 | 88.0 | 10.0 | 6/10 |
| Example 1-6 | 10 | 89.5 | 0.5 | 20 | 0.38 | 50 | 0.6 | 0.99 | 87.0 | 9.8 | 3/10 |
| Example 1-7 | 5 | 50 | 45 | 0.11 | 1.40 | 1 | 2.9 | 0.99 | 86.3 | 11.3 | 2/10 |
| Example 1-8 | 2 | 93 | 5 | 0.4 | 0.64 | 38 | 1.2 | 0.99 | 86.6 | 10.7 | 4/10 |
| Example 1-9 | 4 | 72 | 24 | 0.17 | 1.00 | 23 | 2.0 | 0.99 | 87.8 | 10.1 | 5/10 |
| Example 1-10 | 9 | 85 | 6 | 1.5 | 0.50 | 44 | 0.9 | 0.99 | 87.3 | 9.5 | 4/10 |
| Example 1-11 | 2 | 82 | 16 | 0.125 | 0.87 | 27 | 1.7 | 0.95 | 87.8 | 10.1 | 6/10 |
| Example 1-12 | 2 | 82 | 16 | 0.125 | 0.87 | 28 | 1.7 | 1.05 | 87.9 | 10.1 | 6/10 |

It can be learned from Table 1 that, when the porous carbon material of this application has first pores, second pores, and third pores, and the volume percentage V₁% of first pores and the volume percentage V₂% of second pores are controlled as 0.1≤V₁≤10 and 50≤V₂≤95, the first-cycle Coulombic efficiency of the silicon-carbon material can be enhanced, and the high-temperature swelling suppression performance and compression safety performance of the secondary battery can be improved. In particular, when the porous carbon material satisfies at least one of the following conditions: (1) 0.5≤V₁≤10; (2) 50≤V₂≤85; (3) 5≤V₃≤45; or (4) 0.1≤V₁/V₃≤20, the synergy among the first pores, second pores, and third pores can be improved, thereby further improving the first-cycle Coulombic efficiency of the silicon-carbon material as well as the high-temperature swelling suppression performance and compression safety performance of the secondary battery.

In particular, when the pore volume of the porous carbon material is 0.50 cm³/g to 1.0 cm³/g, the first-cycle Coulombic efficiency, high-temperature swelling suppression performance, and compression safety performance of the secondary battery can be further improved. In particular, when the elastic modulus of the porous carbon material is 1 GPa to 50 GPa, especially in the range of 23 GPa to 44 GPa, the first-cycle Coulombic efficiency, high-temperature swelling suppression performance, and compression safety performance of the secondary battery can be further improved.

In particular, when the grain size of the silicon material is 0.9 nm to 2 nm, the first-cycle Coulombic efficiency of the silicon-carbon material can be enhanced, and the high-temperature swelling suppression performance and compression safety performance of the secondary battery can be improved. In particular, controlling the compacted density of the negative electrode material layer within a range of 0.95 g/cm³ to 1.05 g/cm³ can further improve the first-cycle Coulombic efficiency of the silicon-carbon material as well as the high-temperature swelling suppression performance and compression safety performance of the secondary battery.

### Examples 2-1 to 2-9

The difference from Example 1-1 lies only in that: the mass percentages of propylene carbonate and ethylene carbonate in the electrolyte are adjusted according to Table 2, lithium tetrafluoroborate with a mass percentage S1% and/or lithium bis(trifluoromethanesulfonyl)imide with a mass percentage S2% are added to the electrolyte, and the proportion of the base solvent is adjusted accordingly, where the mass ratio of dimethyl carbonate to diethyl carbonate remains unchanged. The specific adjustments to parameters and performance test results are shown in Table 2.

TABLE 2

| | | | Sum of mass | | | | | |
|---|---|---|---|---|---|---|---|---|
| | | | percentages | | | | | |
| | Mass | Mass | of propylene | Mass | | | High- | |
| | percentage | percentage | carbonate | percentage | Mass percentage | First-cycle | temperature | |
| | of propylene | of ethylene | and ethylene | of lithium | of lithium bis | Coulombic | thickness | |
| | carbonate | carbonate | carbonate E | tetrafluoroborate | (trifluoromethanesulfonyl) | efficiency | swelling | Compression |
| No. | (%) | (%) | (%) | S1 (%) | imide S2 (%) | (%) | rate (%) | test pass rate |
| Example 2-1 | 2 | 6 | 8 | \ | \ | 86.9 | 10.6 | 3/10 |
| Example 2-2 | 4 | 6 | 10 | \ | \ | 87.5 | 10.3 | 5/10 |
| Example 2-3 | 14 | 16 | 30 | \ | \ | 88.3 | 9.9 | 5/10 |
| Example 2-4 | 17 | 16 | 33 | \ | \ | 86.7 | 10.8 | 4/10 |
| Example 2-5 | 12 | 6 | 18 | 0.01 | \ | 89.2 | 9.4 | 7/10 |
| Example 2-6 | 12 | 6 | 18 | 0.05 | \ | 90.6 | 8.7 | 8/10 |
| Example 2-7 | 12 | 6 | 18 | 0.6 | \ | 90.3 | 8.8 | 8/10 |
| Example 2-8 | 12 | 6 | 18 | 0.8 | \ | 89.6 | 9.2 | 7/10 |
| Example 2-9 | 12 | 6 | 18 | 0.6 | 0.05 | 91.0 | 8.5 | 9/10 |
| Example 2-10 | 12 | 6 | 18 | 0.6 | 0.1 | 91.8 | 8.1 | 10/10 |
| Example 2-11 | 12 | 6 | 18 | 0.6 | 0.2 | 91.7 | 8.1 | 10/10 |
| Example 2-12 | 12 | 6 | 18 | 0.6 | 2 | 91.3 | 8.4 | 9/10 |

It can be learned from Table 2 that: when the electrolyte of this application contains propylene carbonate and ethylene carbonate, and the sum E % of the mass percentages of propylene carbonate and ethylene carbonate in the electrolyte is controlled as 10≤E≤30, the first-cycle Coulombic efficiency can be further enhanced, and the high-temperature swelling suppression performance and compression safety performance of the secondary battery can be improved.

In particular, when the electrolyte of this application contains lithium tetrafluoroborate with its mass percentage S1% controlled as 0.01≤S1≤0.8, the first-cycle Coulombic efficiency, high-temperature swelling suppression performance, and compression safety performance of the secondary battery can be further improved. Especially when 0.05≤S1≤0.6 is satisfied, the first-cycle Coulombic efficiency, high-temperature swelling suppression performance, and compression safety performance of the secondary battery can be further improved.

In particular, when the electrolyte of this application contains lithium bis(trifluoromethanesulfonyl)imide with its mass percentage S2% controlled as 0.05 23S2≤2, the first-cycle Coulombic efficiency, high-temperature swelling suppression performance, and compression safety performance of the secondary battery can be further improved. Especially when 0.1≤S2≤1.2 is satisfied, the first-cycle Coulombic efficiency, high-temperature swelling suppression performance, and compression safety performance of the secondary battery can be further improved.

The foregoing descriptions are merely preferred embodiments of this application, but are not intended to limit this application. Any modification, equivalent replacement, or improvement made without departing from the principle of this application shall fall within the protection scope of this application.

What is claimed is:

1. A porous carbon material, wherein the porous carbon material has first pores, second pores, and third pores; wherein each of the first pores has a pore size of P₁ nm and 0<P₁≤1; each of the second pores has a pore size of P₂ nm and 1<P₂≤3; and each of the third pores has a pore size of P₃ nm and 3<P₃≤10; wherein
based on a sum of pore volumes of the first pores, the second pores, and the third pores, a volume percentage of the first pores is V₁%, a volume percentage of the second pores is V₂%, and a volume percentage of the third pores is V₃%; wherein 0.1≤V₁≤10 and 50≤V₂≤95.

2. The porous carbon material according to claim 1, wherein the porous carbon material satisfies at least one of the following conditions:
(1) 0.5≤V₁≤10;
(2) 50≤V₂≤85;
(3) 5≤V₃≤45; or
(4) 0.1≤V₁/V₃≤20.

3. The porous carbon material according to claim 1, wherein a total pore volume of the porous carbon material is in the range of 0.50 cm³/g to 1.0 cm³/g; and/or,
an elastic modulus of the porous carbon material is in the range of 1 GPa to 50 GPa.

4. A method for preparing the porous carbon material according to claim 1, the method comprising following steps:
step S1: carbonizing a carbon precursor in inert gas atmosphere to obtain a carbonized material;
step S2: mixing the carbonized material and a pore-forming agent at a mass ratio of 1:(0.2-2.5) to obtain a mixture; and activating the mixture in inert gas atmosphere to obtain an activated material; wherein the activation treatment comprises sequentially maintaining the temperature at T₁° C. for a duration time of t₁ hours, maintaining the temperature at T₂° C. for a duration time of t₂ hours, and maintaining the temperature at T₃° C. for a duration time of t₃ hours; wherein 700≤T₁≤800, 0.123 t₁≤1; 800<T₂≤900, 4≤t₂≤7; and 900<T₃≤1000, 0.5≤t₃≤4; and
step S3: washing the activated material with water and an acid liquid in sequence, and filtering to obtain the porous carbon material.

5. A silicon-carbon material, comprising a porous carbon material and a silicon material located in pores of the porous carbon material; wherein the porous carbon material has first pores, second pores, and third pores; wherein each of the first pores has a pore size of P1 nm and 0<P1≤1; each of the second pores has a pore size of P2 nm and 1<P2≤3; and each of the third pores has a pore size of P3 nm and 3<P3≤10; wherein based on a sum of pore volumes of the first pores, the second pores, and the third pores, a volume percentage of the first pores is V1%, a volume percentage of the second pores is V2%, and a volume percentage of the third pores is V3%; wherein 0.1≤V1≤10 and 50≤V2≤95; and
a grain size of the silicon material is in the range of 0.9 nm to 2 nm.

6. The silicon-carbon material according to claim 5, wherein the porous carbon material satisfies at least one of the following conditions:
(1) 0.5≤V₁≤10;
(2) 50≤V₂≤85;
(3) 5≤V₃≤45; or
(4) 0.1≤V₁/V₃≤20.

7. The silicon-carbon material according to claim 5, wherein a total pore volume of the porous carbon material is in the range of 0.50 cm³/g to 1.0 cm³/g.

8. The silicon-carbon material according to claim 5, wherein an elastic modulus of the porous carbon material is in the range of 1 GPa to 50 GPa.

9. The silicon-carbon material according to claim 8, wherein the elastic modulus of the porous carbon material is in the range of 23 GPa to 44 GPa.

10. A secondary battery, comprising a positive electrode, a negative electrode, and an electrolyte; wherein the negative electrode comprises a negative electrode current collector and a negative electrode material layer disposed on at least one surface of the negative electrode current collector; and the negative electrode material layer comprises a silicon-carbon material; wherein the porous carbon material has first pores, second pores, and third pores; wherein each of the first pores has a pore size of P₁ nm and 0<P₁≤1; each of the second pores has a pore size of P₂ nm and 1<P₂≤3; and each of the third pores has a pore size of P₃ nm and 3<P₃≤10; wherein
based on a sum of pore volumes of the first pores, the second pores, and the third pores, a volume percentage of the first pores is V₁%, a volume percentage of the second pores is V₂%, and a volume percentage of the third pores is V₃%; wherein 0.1≤V₁≤10 and 50≤V₂≤95; and
a compacted density of the negative electrode material layer is in the range of 0.95 g/cm³ to 1.05 g/cm³.

11. The secondary battery according to claim 10, wherein the porous carbon material satisfies at least one of the following conditions:
(1) 0.5≤V₁≤10;
(2) 50≤V₂≤85; or
(3) 5≤V₃≤45.

12. The secondary battery according to claim 10, wherein 0.1≤V₁/V₃≤20.

13. The secondary battery according to claim 10, wherein a total pore volume of the porous carbon material is in the range of 0.50 cm³/g to 1.0 cm³/g.

14. The secondary battery according to claim 10, wherein an elastic modulus of the porous carbon material is in the range of 1 GPa to 50 GPa.

15. The secondary battery according to claim 14, wherein the elastic modulus of the porous carbon material is in the range of 23 GPa to 44 GPa.

16. The secondary battery according to claim 10, wherein the electrolyte comprises propylene carbonate and ethylene carbonate; and based on a mass of the electrolyte, a sum of mass percentages of the propylene carbonate and the ethylene carbonate is E %, wherein 10≤E≤30.

17. The secondary battery according to claim 16, wherein the electrolyte further comprises lithium tetrafluoroborate; and based on the mass of the electrolyte, a mass percentage of the lithium tetrafluoroborate is S1%, wherein 0.01≤S1≤0.8.

18. The secondary battery according to claim 17, 0.05≤S1≤0.6.

19. The secondary battery according to claim 16, wherein the electrolyte further comprises lithium bis(trifluoromethanesulfonyl)imide; and based on the mass of the electrolyte, a mass percentage of the lithium bis(trifluoromethanesulfonyl)imide is S2%, wherein 0.05≤S2≤2.

20. The secondary battery according to claim 19, wherein 0.1≤S2≤1.2.
